(19) United States
(12) Patent Application Publication
(10) Pub. No.: US 2005/0228683 A1
(43) Pub. Date: Oct. 13, 2005

(54) Integrated use of a portable image capture device into a workflow process

(76) Inventors: Stephen Saylor, South Hamilton, MA (US); Robert P. Morris, Raleigh, NC (US)

Correspondence Address: SAWYER LAW GROUP LLP, P.O. Box 51418, Palo Alto, CA, 94303, US

(21) Appl. No.: 10/823,976

(22) Filed: Apr. 13, 2004

(51) Int. Cl. G06F 17/60

(52) U.S. Cl. 705/1; 705/7

(57) ABSTRACT

Aspects for integrating use of a portable image capture device into a workflow process are described. The aspects include initiating utilization of a portable image capture device with a workflow process, the workflow process including a template having at least one predetermined point at which data input, including captured image data, is expected. The portable image capture device directs collection of the data input and integrates the collected data input into the workflow process by automatically associating the collected data with the template, thereby generating an output document.

### FIELD OF THE INVENTION

The present invention relates to workflow processes, and more particularly to integration of a portable image capture device into a workflow process.

### BACKGROUND OF THE INVENTION

The manner is which a business manages all the steps, including data collection, in its process of providing a service or product can be referred to generally as a workflow process. Numerous workflow processes exist that require the acquisition and incorporation of images into the data associated with the process. Some examples of such workflow processes include images associated with insurance claims processing, real estate listings, online auction listings, construction site management, etc.

Current methods for acquiring and incorporating the images are not fully automated, often requiring multiple devices. For example, a workflow process for a real estate brokerage may begin with a request by a homeowner to list his/her house for sale. Typically, information about the home is collected in order to complete a document on a computer by the real estate broker, while allowing for insertion of a photograph of the property. Note that the document may be formatted in any number of ways including Adobe PDF, Microsoft Office Word, Rich Text Format (RTF), a web page or set of web pages (HTML), etc. A photographer then obtains a photograph of the property, which, if done by using a film-based camera, further requires development before being given to the broker for insertion by the broker onto a property flyer or other document. Alternatively, the photographer captures a digital image of the property with a digital camera and uploads the image to the broker's computer. The broker pastes the image into the document on the computer. The document is then photocopied to create flyers. For the flyers to be available on the Internet, the data and image are transferred to a web page. Performing these steps can occur manually or with the assistance of a tool, e.g., a website builder or document editor.

As in this example scenario, generally, current methods for image acquisition and incorporation within workflow processes require multiple data acquisition devices, along with multiple software programs to link the images with appropriate data. Such multiple, separate, and manual steps are labor intensive, time-consuming, and create increased chance for errors. Accordingly, a need exists for a more automated process that saves time for businesses and workers. The present invention addresses such a need.

### SUMMARY OF THE INVENTION

Aspects for integrating use of a portable image capture device into a workflow process are described. The aspects include initiating utilization of a portable image capture device with a workflow process, the workflow process including a template having at least one predetermined point at which data input, including captured image data, is expected. The portable image capture device directs collection of the data input and integrates the collected data input into the workflow process by automatically associating the collected data with the template, thereby generating an output document.

Through the present invention, a data gatherer is allowed to collect all needed data using one device which automatically associates the captured image, voice, and text data with the appropriate document(s). In one embodiment, the device places the collected images and data in the appropriate locations in the associated templates, thereby creating the documents in the device. Note that templates include documents that may have been created at an earlier step in the workflow process but which require additional data to complete. By definition, a template is input to a particular workflow step. The output of a step is defined as a document. The output document may be input to another workflow step in which case the document is a template from the perspective of the step taking it as input. In another embodiment, the collection and association occurs without requiring the templates or resulting documents to be stored in whole or in part on the device. In this manner, resources and time are saved. In particular, if the document is transmitted over a network, significant time savings in transmission can be realized.

### BRIEF DESCRIPTION OF THE DRAWINGS

FIG. 1 illustrates a block system diagram in accordance with the present invention.

FIG. 2 illustrates a block flow diagram of a method for integrating use of a portable image capture device into a workflow process in accordance with the present invention.

FIG. 3 illustrates a flow diagram of a first embodiment of the method of FIG. 2.

FIG. 4 illustrates a flow diagram of a second embodiment of the method of FIG. 2.

### DETAILED DESCRIPTION OF THE INVENTION

The present invention relates to the integration of a portable image capture device into a workflow process. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

With the present invention, a portable image capture device is integrated into a workflow process to improve efficiency and productivity. As is generally understood, a workflow process refers to the manner by which all of the steps necessary for provision of a business service/product occur. Integration of a portable image capture device into a workflow process is applicable to many business services, with particular application for those requiring image capture, including, for example, insurance claim services, medical diagnostic and treatment services, real estate listing services, etc.

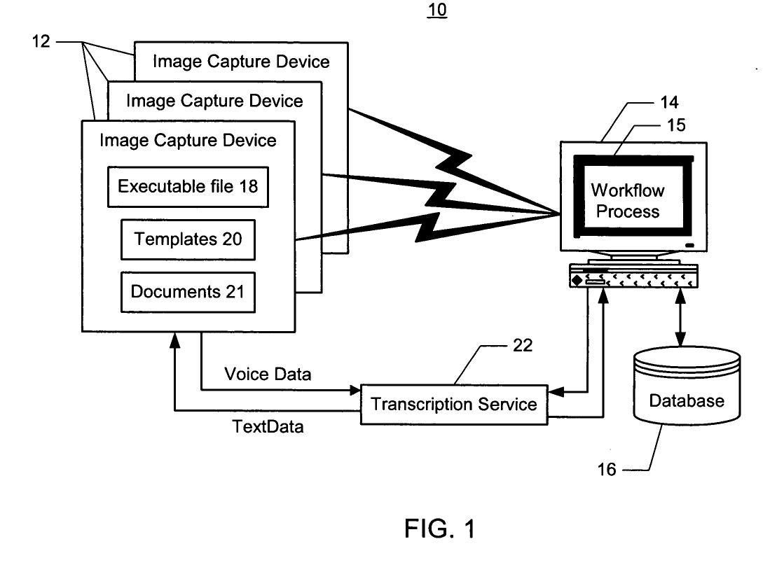

FIG. 1 is a diagram illustrating a system for integrating a portable image capture device into a workflow process in accordance with preferred embodiment of the present invention. The system 10 includes one or more portable image capture devices 12 coupled to a computer system 14, preferably via a network. The image capture device 12 is equipped to capture digital images and to optionally enable the recording of sound/voice and the capture of text in a digital format. The image capture device 12 may also provide wireless networking services. Examples of portable image capture devices that meet these criteria and are available for business consumer use include camera-enabled cellular telephones and personal digital assistants (PDAs), digital cameras, and the like.

The computer system 12 comprises a network connected PC or web server that may communicate with the image capture device, such as through a wireless communication connection. The computer system 12 in conjunction with the image capture device 12 perform part or all of a workflow process 15, which may be stored in database 16.

The image capture device 12 is provided with an executable file 18, which may be built-in or downloaded from the computer system 14, for execution by the image capture device 12. In the preferred embodiment, the executable file could be a script, an application, an applet, or a data file. The executable file 18 includes instructions concerning the workflow process and one or more templates 20 that require input captured by the image capture device 12 in order to create documents. According to the present invention, through the executable file 18, the image capture device 12 directs a user to capture certain data, and then automatically inserts the data into corresponding locations in the template 20 and thus creating a document 21, thereby automating part or all of the workflow process, such as the generation of catalog or web pages. Some workflow processes require verification that the document 21 has been created by an authorized party and that it has not be modified by any unauthorized party. The advantage of generating documents 21 on the device 12 is that documents 21 can be created using a format that supports document signing such as PDF. This prevents tampering with the document 21 as it moves through the workflow process. Formats such as PDF also allow verification of the time a document 21 was created.

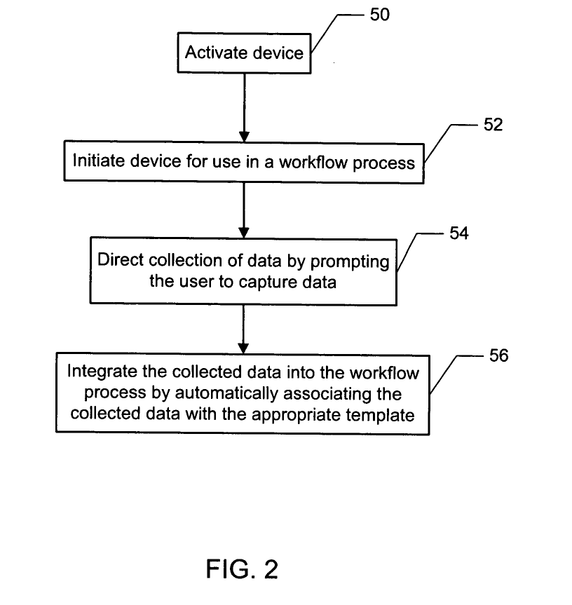

A method for integrating the portable image capture device 12 into a workflow process is described with reference to the block flow diagram of FIG. 2. The process ensues with activation of the device 12 (step 50). The activation includes a user turning on the portable image capture device 12 and entering any necessary authentication data (e.g., voice, text, biometric, electronic). Once activated, initiation of the device 12 for use in a workflow process occurs by executing the appropriate executable file 18 (step 52). Once the workflow process is initiated, the device 12 directs collection of data by prompting the use to capture data (step 54). For example, when a template 20 has been selected retrieved in the first embodiment, certain places in the template 20 are recognized by the device 12 as requiring data input, usually in the form of an image. Once the data collection directing is completed, the executable file 18 integrates the collected data into the workflow process by automatically associating the collected data with the template 20 thereby creating a new document 21 (step 56). If needed, the document 21 can be generated in a format which can be digitally signed in order to verify the creator and the time created.

Through the integration of a portable image capture device 12 with a workflow process in the present invention, the number of manual steps required is reduced, thus saving time and reducing errors. Further, only one data capture device 12 is required, which reduces effort and saves expense in terms of time and the cost of tools. Security is enhanced, since fewer people are needed to capture and process the data. Performance is further improved when using links, since the overhead of storing, transferring, and processing documents is not required during the data gathering and processing steps.

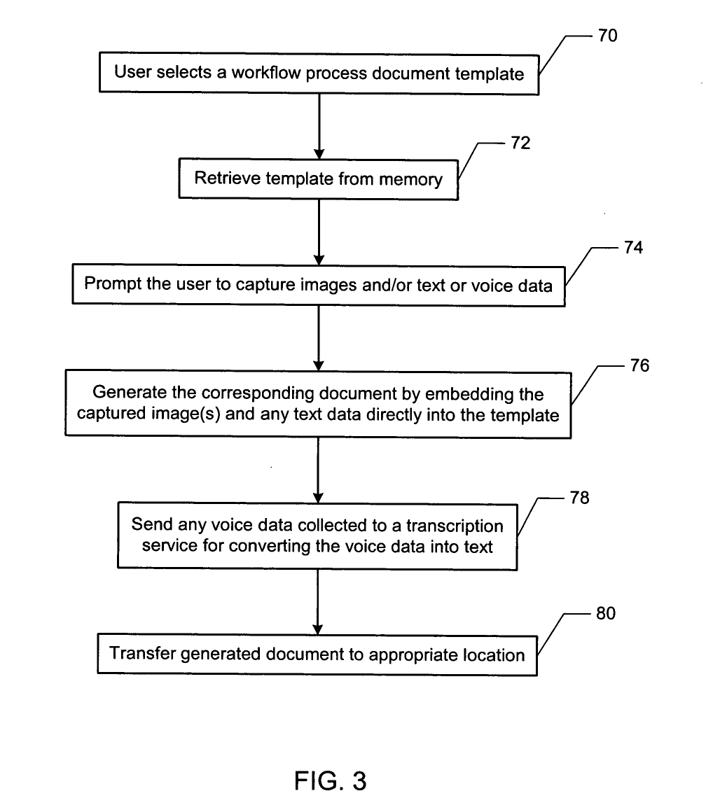

FIG. 3 is a flow diagram illustrating the method of FIG. 2 in further detail in accordance with a first preferred embodiment of the present invention. In this embodiment, workflow initiation occurs by the user selecting a workflow process document template, e.g., an insurance claim form template, from a displayed list of available templates in the device 12 (step 70). The templates(s) 20 are retrieved from memory (step 72), such as from storage on a memory card device that is inserted in/made accessible to the device 12 or they may be received via a network connection. Thus, for each of the places in the template 20 recognized as requiring the input of data, the device 12 prompts the user (step 74), such as through audio or visual prompts, to capture specific images and/or to enter text or voice data for the one or more predetermined data entry points. The device 12 then generates the corresponding document 21 by embedding the captured image(s) and any text data directly into the template 20 (step 76).

According to the present invention, any voice data collected is sent to a transcription service 22 that converts the voice data into text (step 78), and the text is inserted into the document 21. When the device 12 has network capabilities, the generated document 21 is transferred to an appropriate location in the workflow process (step 80). For example, a completed document may be e-mailed to another worker, may be automatically added to a database, may be printed for placement in a file, etc. Alternatively, for a device 12 without network capabilities, the generated document may be uploaded to a PC for the transfer to the appropriate location in the workflow process.

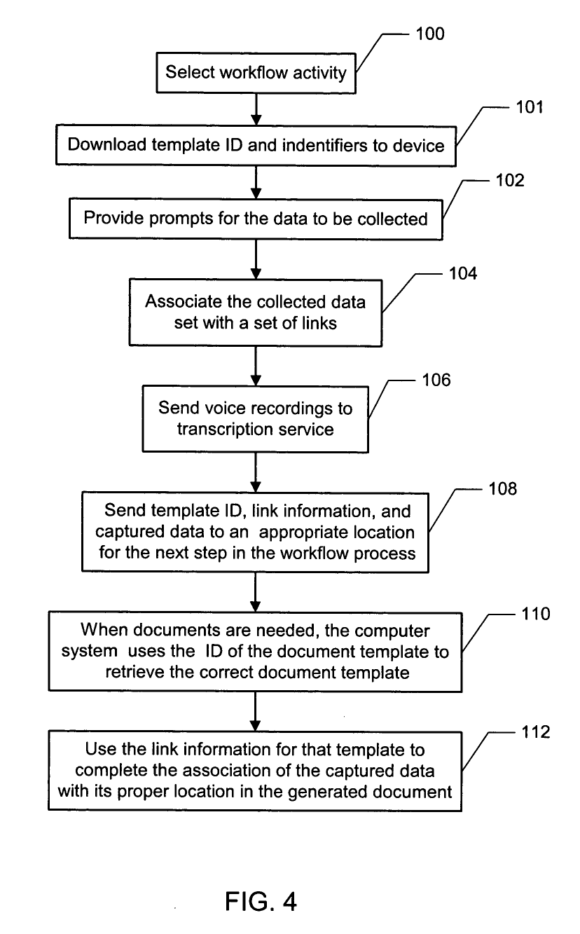

FIG. 4 is a flow diagram illustrating the method of FIG. 2 in further detail in accordance with a second preferred embodiment of the present invention. In the second embodiment of the present invention, workflow initiation occurs by selection of the workflow activity (step 100), either by the user or by a configured, preset selection in the device 12, e.g., selection of an insurance claim activity. In this alternate embodiment, the full document template(s) 20 themselves are not stored on the device 12 or received by the device 12 over a network. Rather, workflow activities are provided by associating a set of input identifiers and a template identifier (ID) with a particular workflow activity. Either before or after selection of the workflow activity, the template ID and input identifiers are downloaded to the device 12, preferably from the computer system 14 (step 101).

When the selected workflow activity is initiated, the device 12 prompts the user for the data to be collected (step 102), where the association of the workflow activity to a particular template ID indicates to the device 12 which data is needed. In a preferred embodiment, each available workflow activity 15 is associated with a set of input identifiers using a template identifier (ID), where each template ID has an associated set of input identifiers which link the data to be capture to appropriate places in the identified template 20. The terms link and input identifier are used interchangeably. These input identifiers may also indicate to the device 12 the prompts needed for data collection. In order to utilize the data, preferably a naming convention is chosen that allows for association of each collected data set with the input identifiers (step 104). For example, this may be done by generating separate files for the data collected, such that each file has a name that matches the input identifier to which it is associated. Alternately, the device 12 can generate a single file containing the image, text data or voice recording and each input identifier is associated with the name of the file. Or, the device can embed the image, data, and/or voice recording in the same file as the associated input identifier(s). Of course, any combination of these methods may be used.

If some of the data entered is voice data, then the template ID, input identifier data for the voice data, and voice recordings are sent to a transcription service 22 (step 106), which extracts the voice data and converts the voice to text, then associates the input identifiers with the transcribed text through one of the linking methods. If the device 12 has network capabilities, the device 12 transfers the template ID, input identifier information, captured data, and any transcribed data to the appropriate location for the next step in the workflow process (step 108). Otherwise, the data is uploaded to the computer system 12 where it is then transferred to the appropriate location for the next step in the workflow process. When documents are needed, the computer system 12 uses the template ID of the needed to retrieve the correct template 20 (step 110). The input identifier information for that template 20 is then used in order to complete the association of the captured data with its proper location in the generated document 21 (step 112).

A method and system for integrating use of a portable image capture device into a workflow process has been disclosed. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A method for integrating use of a portable image capture device into a workflow process, the method comprising:
initiating utilization of a portable image capture device with a workflow process, the workflow process including a template having at least one predetermined point at which data input, including captured image data, is expected;
directing collection of the data input by the portable image capture device; and
integrating the collected data input in the workflow process by automatically associating the collected data with the template, thereby generating an output document.

2. The method of claim 1 wherein initiating utilization further comprises selecting a template for the workflow process in the portable image capture device.

3. The method of claim 2 wherein directing collection further comprises prompting for performance of an image capture at the at least one predetermined point in the template.

4. The method of claim 3 wherein directing collection further comprises prompting for entering of any voice data and text data at the at least one predetermined point in the template.

5. The method of claim 4 wherein integrating the collected data input further comprises inserting the image captured and the voice or text data input at the at least one predetermined point of the template.

6. The method of claim 5 wherein inserting any voice data further comprises transcribing voice data to text data.

7. The method of claim 5 further comprising providing the document for a next step in the workflow process.

8. The method of claim 1 wherein initiating utilization further comprises selecting a workflow activity for the workflow process in the portable image capture device, the workflow activity associated by an identifier with a document template, the template identifier having an associated set of input identifiers for data input.

9. The method of claim 8 wherein directing collection further comprises prompting for performance of an image capture at the at least one predetermined point.

10. The method of claim 9 wherein directing collection further comprises prompting for entering of any voice data and text data at the at least one predetermined point.

11. The method of claim 10 wherein integrating the collected data input further comprises associating the set of input identifiers for the selected workflow activity with the image captured and the voice or text data input.

12. The method of claim 11 wherein inserting any voice data further comprises transcribing voice data to text data.

13. The method of claim 11 further comprising providing the set of input identifiers for a next step in the workflow process.

14. A system for automated integration of image acquisition and incorporation into a workflow process, the system comprising:
a computer system for performing a workflow process, the workflow process including a template having at least one predetermined point at which data input, including captured image data, is expected; and
a portable image capture device capable of at least digital image capture, the portable image capture device directing collection of the data input and integrating the collected data input into the workflow process by automatically associating the collected data with the template, thereby generating an output document.

15. The system of claim 14 wherein the portable image capture device directs collection by prompting for performance of an image capture at the at least one predetermined point.

16. The system of claim 15 wherein the portable image capture device further directs collection by prompting for entering of any voice data and text data at the at least one predetermined point.

17. The system of claim 16 wherein inserting any voice data further comprises transcribing voice data to text data.

18. The system of claim 16 wherein the portable image capture device integrates collected data input by inserting the image captured and the voice or text data input at the at least one predetermined point of a document.

19. The system of claim 18 wherein the portable image capture device further provides the document to the computer system for a next step in the workflow process.

20. The system of claim 16 wherein the portable image capture device integrates collected data input by associating a set of input identifiers for a selected workflow activity with the image captured and the voice or text data input.

21. The system of claim 20 wherein the portable image capture device provides the set of input identifiers, the collected data input, the template identifier to the computer system for a next step in the workflow process.

22. A portable image capture device containing program instructions on a computer readable medium for automation of image integration into a workflow process, the program instructions comprising:
directing collection of data input of at least captured image data for a workflow process, the workflow process including a template having at least one predetermined point at which the at least captured image data, is expected; and
integrating the collected data input into the workflow process by automatically associating the collected data with the template, thereby generating an output document.

23. The portable image capture device of claim 22 wherein directing collection further comprises prompting for entering of any voice data and text data at the at least one predetermined point.

24. The portable image capture device of claim 23 wherein integrating the collected data input further comprises inserting the at least captured image data and the voice or text data input at the at least one predetermined point of a document.

25. The portable image capture device of claim 23 wherein integrating the collected data input further comprises associating a set of input identifiers for a selected workflow activity with the at least captured image data and the voice or text data input.
